(19) United States
(12) Patent Application Publication
(10) Pub. No.: US 2021/0373452 A1
(43) Pub. Date: Dec. 2, 2021

(54) PRINT AGENT APPLICATION ASSEMBLY ELECTRODES

(71) Applicant: Hewlett- Packard Development Company, L.P., Spring, TX (US)

(72) Inventors: Tal Eluk, Ness Ziona (IL); Yaniv Yona, Ness Ziona (IL); Eyal Negreanu, Ness Ziona (IL)

(73) Assignee: Hewlett- Packard Development Company, L.P., Spring, TX (US)

(21) Appl. No.: 17/255,702

(22) PCT Filed: Feb. 14, 2019
(86) PCT No.: PCT/US2019/018075

§ 371 Date: Dec. 23, 2020

(51) Int. Cl. G03G 15/06; G03G 15/08

(52) U.S. Cl. CPC G03G 15/065; G03G 15/0812

(57) ABSTRACT

A print agent application assembly is disclosed. The print agent application assembly includes a print agent transfer roller to receive print agent and transfer a portion of the print agent to a photoconductive surface. The print agent application assembly may further include an electrode to provide an electric charge to the print agent transfer roller. The print agent transfer roller and the electrode may define walls of a cavity through which print agent is to pass. The electrode may comprise an aperture via which a portion of the print agent is able to exit the cavity. A method and a print apparatus are also disclosed.

### BACKGROUND

In the field of printing, print agent may be transferred between surfaces using rollers. One printing technology that may employ the use of a roller is liquid electrophotography (LEP). LEP printing involves the transfer of electrically-charged liquid ink via a series of rollers to a substrate.

### BRIEF DESCRIPTION OF DRAWINGS

Examples will now be described, by way of non-limiting example, with reference to the accompanying drawings, in which:

FIG. 1 is a sectional representation of an example of a print agent application assembly;

FIG. 2 is a schematic illustration of an example of a print agent application assembly;

FIG. 3 is a schematic illustration of an example of a portion of a print agent application assembly;

FIG. 4 is an illustration of an example of an electrode of a print agent application assembly;

FIG. 5 is a flowchart of an example of a method of applying print agent to a print agent transfer roller;

FIG. 6 is a flowchart of a further example of a method of applying print agent to a print agent transfer roller;

FIG. 7 is a schematic illustration of an example of a print apparatus; and

FIG. 8 is a schematic illustration of a further example of a print apparatus.

### DETAILED DESCRIPTION

In a liquid electrophotography (LEP) print apparatus, print agent, such as ink, may pass through a print agent application assembly, such as a binary ink developer (BID). Each BID handles print agent of a particular colour, so an LEP printing system may include, for example, seven BIDs. Print agent from a BID is selectively transferred from a print agent transfer roller—also referred to as a developer roller—of the BID in a layer of substantially uniform thickness to a photoconductive surface, such as a photo imaging plate (PIP). The selective transfer of print agent is achieved through the use of an electrically-charged print agent, also referred to as a “liquid electrophotographic ink”. As used herein, a “liquid electrophotographic ink” or “LEP ink” generally refers to an ink composition, in liquid form, generally suitable for use in a liquid electrostatic printing process, such as an LEP printing process. The LEP ink may include chargeable particles of a resin and a pigment/colourant dispersed in a liquid carrier.

The LEP inks referred to herein may comprise chargeable particles comprising a colourant and a thermoplastic resin dispersed in a carrier liquid. In some examples, the chargeable particles are suspended in the carrier liquid. In some examples, the thermoplastic resin may comprise a copolymer of an alkylene monomer and a monomer selected from acrylic acid and methacrylic acid. In some examples, the thermoplastic resin may comprise a copolymer of an ethylene acrylic acid resin, an ethylene methacrylic acid resin or combinations thereof. In some examples, the thermoplastic resin may comprise an ethylene acrylic acid resin, an ethylene methacrylic acid resin or combinations thereof. In some examples, the carrier liquid is a hydrocarbon carrier liquid such as an isoparaffinic carrier liquid, for example Isopar-L™ (available from EXXON CORPORATION). In some examples, the electrostatic ink also comprises a charge director and/or a charge adjuvant. In some examples, the charge adjuvant includes aluminum di- or tristearate. In some examples, the liquid electrostatic inks described herein may be Electrolnk® and any other Liquid Electro Photographic (LEP) inks developed by Hewlett-Packard Company.

The thermoplastic resin may be selected from ethylene acrylic acid copolymers; methacrylic acid copolymers; ethylene methacrylic acid copolymers; ethylene vinyl acetate copolymers; copolymers of ethylene (e.g. 80 wt % to 99.9 wt %) and alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl may include from 1 to about 20 carbon atoms, such as methyl methacrylate (e.g. 50 wt % to 90 wt %)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

In some examples, the thermoplastic resin comprises a first polymer that is a copolymer of ethylene or propylene and an ethylenically unsaturated acid of either acrylic acid or methacrylic acid. In some examples, the first polymer is absent ester groups and the thermoplastic resin further comprises a second polymer having ester side groups that is a co-polymer of (i) a first monomer having ester side groups selected from esterified acrylic acid or esterified methacrylic acid, (ii) a second monomer having acidic side groups selected from acrylic or methacrylic acid and (iii) a third monomer selected from ethylene and propylene.

Prior to liquid electrostatic printing the resin may constitute 5% to 99% by weight of the solids in the liquid electrostatic ink composition, in some examples, 50% to 90% by weight of the solids of the liquid electrostatic ink composition, in some examples, 70% to 90% by weight of the solids of the liquid electrostatic ink composition. The remaining wt % of the solids in the liquid electrostatic ink composition may be the colorant and, in some examples, any other additives that may be present.

In some examples, the liquid electrostatic ink further comprises a carrier liquid and the chargeable particles comprising a thermoplastic resin may be suspended in the carrier liquid. Generally, the carrier liquid acts as a dispersing medium for the other components in the liquid electrostatic ink. For example, the carrier liquid can comprise or be a hydrocarbon, silicone oil, vegetable oil, etc. The carrier liquid can include, but is not limited to, an insulating, non-polar, non-aqueous liquid that is used as the medium for the chargeable particles. The carrier liquid can include compounds that have a resistivity in excess of about 10⁹ ohm·cm. The carrier liquid may have a dielectric constant below about 30, in some examples, below about 10, in some examples, below about 5, in some examples, below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquid include, but are not limited to, aliphatic hydrocarbons, isoparaffinic compounds, paraffinic compounds, dearomatized hydrocarbon compounds, and the like. In particular, the carrier liquid can include, but is not limited to, Isopar-G™, Isopar-H™, Isopar-L™, Isopar-M™, Isopar-K™, Isopar-V™, Norpar 12™, Norpar 13™, Norpar 15™, Exxol 040™, Exxol 080™, Exxol 0100™, Exxol 0130™, and Exxol 0140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

In some examples, prior to liquid electrostatic printing, the carrier liquid constitutes about 20 to 99.5% by weight of the liquid electrostatic ink, in some examples, 50 to 99.5% by weight of the liquid electrostatic ink. In some examples, prior to liquid electrostatic printing, the carrier liquid constitutes about 40 to 90% by weight of the liquid electrostatic ink. In some examples, prior to liquid electrostatic printing, the carrier liquid constitutes about 60 to 80% by weight of the liquid electrostatic ink. In some examples, prior to liquid electrostatic printing, the carrier liquid may constitute about 90 to 99.5% of the liquid electrostatic ink, in some examples, 95 to 99% of the liquid electrostatic ink.

In some examples, the liquid electrostatic ink may further comprise a colorant. In some examples, the chargeable particles comprising the resin may further comprise a colorant. The colorant may be a dye or pigment. The colorant may be any colorant compatible with the carrier liquid and useful for liquid electrostatic printing. For example, the colorant may be present as pigment particles, or may comprise a resin (in addition to the polymers described herein) and a pigment. The resins and pigments can be any of those commonly used as known in the art. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant 35 Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW 5GT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUEL 710 10 IF, HELIOGEN® BLUEL 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul 15 Uhlich including UHLICH® BK 8200.

In some examples, the liquid electrostatic ink may comprise a charge director. A charge director can be added to a liquid electrostatic ink composition to impart a charge of a desired polarity and/or maintain sufficient electrostatic charge on the particles of a liquid electrostatic ink. The charge director may comprise ionic compounds, including, for example, metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, and the like. The charge director may be selected from oil-soluble petroleum sulfonates (e.g., neutral Calcium Petronate™, neutral Barium Petronate™, and basic Barium Petronate™), polybutylene succinimides (e.g., OLOA™ 1200 and Amoco 575), and glyceride salts (e.g., sodium salts of phosphated mono- and diglycerides with unsaturated and saturated acid substituents), sulfonic acid salts including, for example, barium, sodium, calcium, and aluminium salts of sulfonic acid. The sulfonic acids may include, for example, alkyl sulfonic acids, aryl sulfonic acids, and sulfonic acids of alkyl succinates. The charge director may impart a negative charge or a positive charge on the resin-containing particles of an electrostatic ink composition.

The charge director can comprise a sulfosuccinate moiety of the general formula: [Rₐ—O—C(O)CH₂CH(SO₃⁻)C(O)—O—R_{b}], in which each of Rₐ and R_{b} is an alkyl group. In some examples, the charge director comprises nanoparticles of a simple salt and a sulfosuccinate salt of the general formula MA_{R}, wherein M is a metal, n is the valence of M, and A is an ion of the general formula [Rₐ—O—C(O)CH₂CH(SO₃)C(O)—O—R_{b}], in which each of Rₐ and R_{b} is an alkyl group. The sulfosuccinate salt of the general formula MAₙ is an example of a micelle forming salt. The charge director may be substantially free of or free of an acid of the general formula HA, in which A is as described above. The charge director may comprise micelles of said sulfosuccinate salt enclosing at least some of the nanoparticles. The charge director may comprise at least some nanoparticles having a size of 200 nm or less, in some examples, 2 nm or more. Simple salts are salts that do not form micelles by themselves, although they may form a core for micelles with a micelle forming salt. The ions constructing the simple salts are all hydrophilic. The simple salt may comprise a cation selected from Mg, Ca, Ba, NH₄, tert-butyl ammonium, Li⁺, and Al³⁺, or from any sub-group thereof. The simple salt may comprise an anion selected from SO₄²⁻, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄, and LiBF₄, or any sub-group thereof. The charge director may further comprise basic barium petronate (BBP).

In the formula [Rₐ—O—C(O)CH₂CH(SO₃⁻)C(O)—O—R_{b}], in some examples, each of Rₐ and R_{b} is an aliphatic alkyl group. In some examples, each of Rₐ and R_{b} independently is a C₆₋₂₅ alkyl group. In some examples, said aliphatic alkyl group is linear. In some examples, said aliphatic alkyl group is branched. In some examples, said aliphatic alkyl group includes a linear chain of 6 carbon atoms or more. In some examples, Rₐ and R_{b} are the same. In some examples, at least one of Rₐ and R_{b} is C₁₃H₂₇. In some examples, M is Na, K, Cs, Ca, or Ba.

The charge director may comprise (i) soya lecithin, (ii) a barium sulfonate salt, such as basic barium petronate (BBP), and (iii) an isopropyl amine sulfonate salt. Basic barium petronate is a barium sulfonate salt of a 21-26 carbon atom hydrocarbon alkyl chain, and can be obtained, for example, from Chemtura. An example isopropyl amine sulfonate salt is dodecyl benzene sulfonic acid isopropyl amine, which is available from Croda.

In a liquid electrostatic ink, the charge director may constitute about 0.001% to 20% by weight, in some examples, 0.01 to 20% by weight, in some examples, 0.01 to 10% by weight, in some examples, 0.01 to 1% by weight of the solids of a liquid electrostatic ink. The charge director can constitute about 0.001 to 0.15% by weight of the solids of a liquid electrophotographic, in some examples, 0.001 to 0.15% by weight, in some examples, 0.001 to 0.02% by weight of the solids of a liquid electrophotographic ink. In some examples, a charge director imparts a negative charge on an electrostatic ink composition. The particle conductivity may range from 50 to 500 pmho/cm, in some examples, from 200-350 pmho/cm.

A liquid electrostatic may include a charge adjuvant. A charge adjuvant may be present with a charge director, and may be different to the charge director, and act to increase and/or stabilise the charge on the chargeable particles, for example, resin-containing particles, of a liquid electrostatic ink. The charge adjuvant may include barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In some examples, the charge adjuvant is aluminium di- and/or tristearate and/or aluminium di- and/or tripalmitate.

The charge adjuvant may constitute about 0.1 to 5% by weight of the solids of a liquid electrostatic ink. The charge adjuvant may constitute about 0.5 to 4% by weight of the solids of a liquid electrostatic ink. The charge adjuvant may constitute about 1 to 3% by weight of the solids of a liquid electrostatic ink.

In some examples, a liquid electrostatic ink may include an additive or a plurality of additives. The additive or plurality of additives may be added at any stage of the production of the liquid electrostatic ink composition. The additive or plurality of additives may be selected from a wax, a surfactant, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the resin. Specifically, the wax phase separates from the resin phase upon cooling of the resin fused mixture during and after the transfer of the ink film to the print medium, for example, from an intermediate transfer member, which may be a heated blanket.

Thus, in some examples, the liquid electrostatic ink comprises chargeable particles. During electrostatic printing the chargeable particles may separate into charged ink particles and counterions. Various components of the chargeable particles may separate into ions and counterions. As noted above, the chargeable particles may comprise a thermoplastic resin and a colorant.

In some example, the thermoplastic resin may comprise a polymer having acid side groups. During printing the acid side groups may separate into a negatively charged polymer and H⁺, providing the chargeable particles with a negative charge. In some examples, the thermoplastic resin may comprise a copolymer of an alkylene monomer and a monomer selected from methacrylic acid and acrylic acid. During printing the methacrylic acid or acrylic acid may separate into methacrylate or acrylate and H⁺. The methacrylate or acrylate containing resin remains part of the charged ink particles (negatively charged particles) and the H⁺ is a counterion (positively charged particle).

The chargeable particles may further comprise a charge director. The charge director may comprise a metal salt of a sulfosuccinate. During printing, the sulfosuccinate remains part of the charged ink particles (which are therefore negatively charged) while the metal is a counterion (positively charged particle).

The chargeable particles may further comprise a charge adjuvant. The charge adjuvant may comprise a metal salt of a carboxylic acid. During printing, the carboxylate remains part of the charged ink particles (negatively charged particles) while the metal is a counterion (positively charged particles).

During the printing process, the entire PIP of the print apparatus is charged, then areas representing an image to be printed are discharged. Print agent (e.g. LEP ink) is transferred to those portions of the PIP that have been discharged. The PIP transfers the print agent to a printing blanket, which subsequently transfers the print agent onto a printable substrate, such as paper. The discharged portions of the PIP represent the portion or portions of a pattern or image in which print agent from the BID is to be applied to the substrate. Print agent that is not transferred from the developer roller to the PIP (i.e. in those areas where the PIP remains charged) remains on the developer roller of the BID, and is removed from the developer roller by components within the BID, such as a cleaner roller.

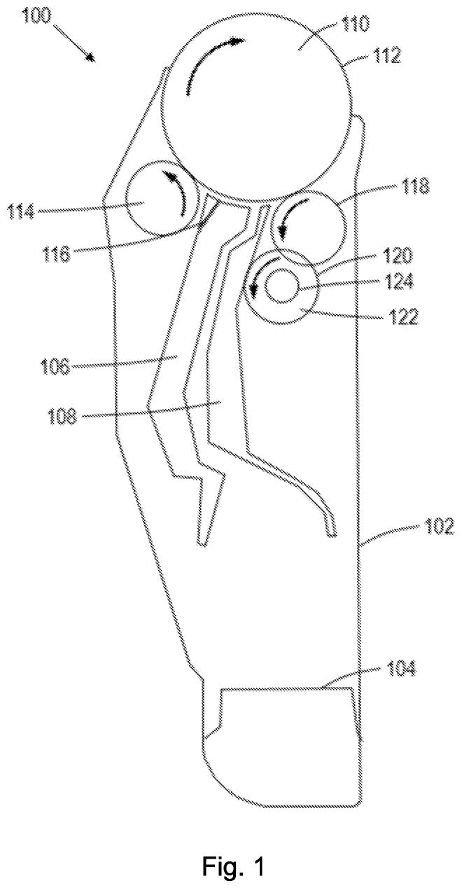

FIG. 1 is a sectional representation of a print agent application assembly 100. For clarity, some components of the print agent application assembly 100 are not shown in FIG. 1.

The print agent application assembly 100 includes a housing 102 (also referred to as a BID tray) within which other components are at least substantially disposed. An ink tray 104 is formed near to the bottom of the housing 102, to catch unused print agent. The ink tray 104 may be referred to as an ink capture tray. The assembly 100 includes a first electrode 106 and a second electrode 108. In the examples described herein, the first electrode 106, also referred to as a main electrode, may carry a negative charge. In other examples, however, the first electrode 106 may carry a positive charge. The second electrode 108, may also be referred to as a back electrode. The second electrode 108 may carry the same charge as the first electrode 106 or, in some examples, the second electrode may be electrically isolated. Print agent may travel from a print agent reservoir (not shown), which may be located outside the print agent application assembly 100, between the first and second electrodes 106, 108, towards a first roller, referred to as a print agent transfer roller or developer roller 110. The developer roller 110 rotates in a direction shown in FIG. 1. An electric field formed between the first electrode 106 and the developer roller 110 causes print agent to be attracted to the developer roller, to thereby form a film or coating of print agent on a surface 112 of the developer roller.

The assembly 100 further includes a second roller, referred to as a print agent regulator roller or squeegee roller 114, which rotates in a direction opposite to the direction of rotation of the developer roller 110, as shown in FIG. 1. The squeegee roller 114 is urged towards the developer roller 110 so as to compact and remove excess liquid from the print agent that coats the developer roller. Further, in some examples, an electric charge may be applied the squeegee roller 114 to create an electric field between the squeegee roller and the developer roller 110. The electric field causes the print agent to be attracted to a greater extent to the developer roller 110, thereby further compacting the print agent film formed thereon. The effect of the constant mechanical and electric forces applied from the squeegee roller 114 to the developer roller 110 is that the film of print agent on the developer roller is of substantially uniform thickness.

Some print agent that travels between the first and second electrodes 106, 108, is caused to flow between the first electrode 106 and the developer roller 110 towards the squeegee roller 114. If print agent encounters the squeegee roller at too high a flow rate, then print agent may splash onto the developer roller, thereby affecting the layer of print agent formed on the surface of the developer roller, and thereby resulting in a non-uniform layer of print agent. More generally, print agent encountering the region where the squeegee roller 114 and the developer roller 110 meet may result in turbulent flow or high-shear flow if the print agent flow rate is too high.

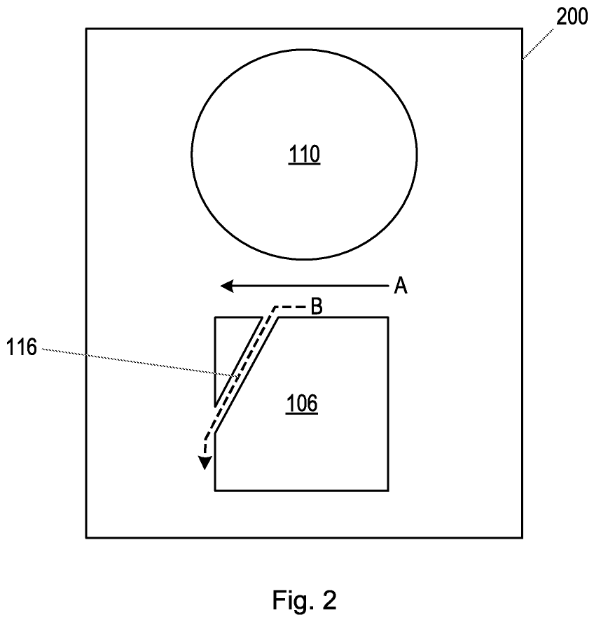

According to the present disclosure, the flow-rate of print agent between the first electrode 106 and the developer roller 110 may be reduced by providing a channel or aperture 116 through the first electrode, thereby allowing some of the print agent to leave the region between the first electrode and the developer roller before it encounters the squeegee roller 114. In this way, the occurrence and/or the effects of turbulent flow or high-shear flow may be reduced. The effect of the aperture 116 is discussed in greater detail below, with reference to FIG. 2.

Print agent that is not transferred from the developer roller 110 to the photo imaging plate is referred to as unused print agent. A cleaner roller 118 is disposed within the assembly 100 adjacent to the developer roller 110, and rotates in a direction opposite to the direction of rotation of the developer roller 110, as shown in FIG. 1. The cleaner roller 118 is electrically charged and attracts electrically-charged print agent, thereby cleaning unused print agent from the developer roller 110.

The assembly 110 also includes a sponge roller 120, which includes an absorbent material 122, such as a sponge, mounted around a core 124. The sponge roller 120 rotates in the same direction as the cleaner roller, as shown in FIG. 1. The sponge roller 120 is mounted adjacent to the cleaner roller, such that, as the sponge roller rotates, the absorbent material 122 absorbs the unused print agent from the surface of the cleaner roller. The absorbent material 122 of the sponge roller has a number of open cells, or pores, for absorbing liquid, such as the unused print agent. In some examples, the absorbent material 122 may be open-cell polyurethane foam. Print agent absorbed by the absorbent material 122 may then be squeezed from the sponge roller 120 into the ink tray 104. Print agent (e.g. unused print agent captured in the ink tray 104) may be drained from the ink tray and returned to the print agent reservoir.

FIG. 2 is a schematic illustration of an example of a print agent application assembly 200. The print agent application assembly 200 may comprise the print agent application assembly 100 shown in FIG. 1. For clarity, like reference numerals are used for like features in FIGS. 1 and 2. The print agent application assembly 200 includes a print agent transfer roller 110 to receive print agent and transfer a portion of the print agent to a photoconductive surface (not shown). The print agent application assembly 200 also includes an electrode 106 to provide an electric charge to the print agent transfer roller 110. The print agent transfer roller 110 and the electrode 106 defined walls of a cavity or region through which print agent is to pass. For example, print agent may pass between the print agent transfer roller 110 and the electrode 106 in the direction shown by the arrow A. The electrode 106 comprises an aperture 116 via which a portion of the print agent is able to exit the cavity. For example, a portion of the print agent flowing between the print agent transfer roller 110 and the electrode 106 may flow through the aperture 116, away from the cavity, in a direction shown by the dashed arrow B.

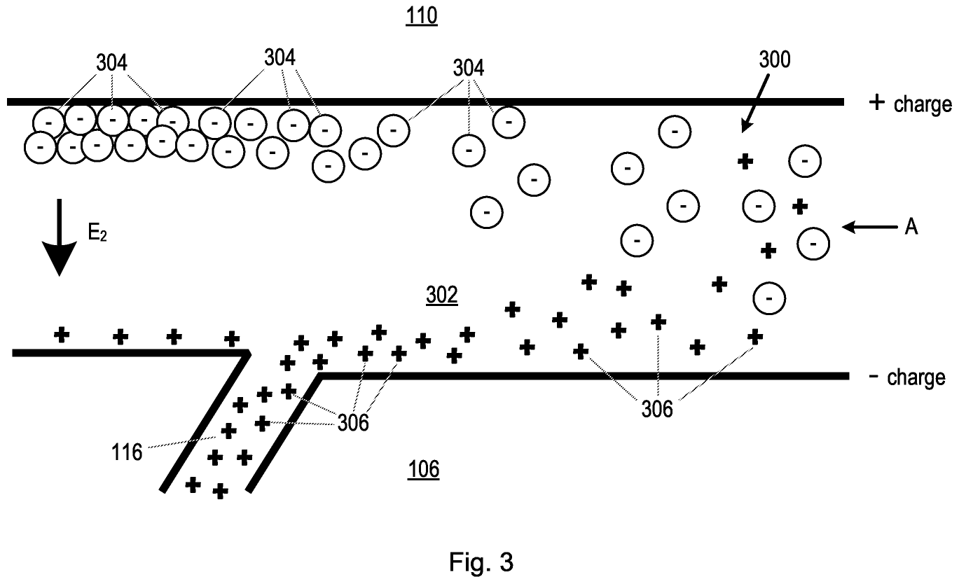

FIG. 3 is a schematic illustration of an example of a portion of a print agent application assembly, such as the assembly 100 or 200. More specifically, FIG. 3 illustrates a cavity 300 or a passage, walls of which are defined by the print agent transfer roller 110 and the electrode 106. As noted previously, print agent 302 flows through the cavity 300, between the print agent transfer roller 110 and the electrode 106, towards the squeegee roller (FIG. 1; 114). The aperture or outlet 116 formed in the electrode 106 provides an alternative route that a portion of the print agent 302 can take. The electrode (e.g. the first electrode) 106 is, in this example, negatively charged, and the print agent transfer roller 110 is positively charged. Therefore, a potential difference (and hence an electric field, E) is formed between the print agent transfer roller 110 and the electrode 106. As noted above, in some printing systems, such as LEP printing systems, electrically charged print agent (e.g. LEP ink) 302 is used, and in such systems print agent flowing through the cavity 300 will feel the effects of the electric field, E. As shown in FIG. 3, charged particles 304 of print agent 302 (in this case, negatively-charged particles) are attracted to the print agent transfer roller 110 as they move through the cavity 300. Non-charged particles (e.g. particles of liquid carrier) in the print agent 302 are not attracted to the print agent transfer roller 110 and, therefore, continue to flow through the cavity 300 in the direction shown by arrow A. Any positively-charged particles 306 in the print agent (e.g. counterions) may be attracted to the negatively-charged electrode 106.

Thus, more generally, the electrode 106 may, in some examples, comprise a negatively-charged electrode, and the print agent in the cavity may comprise positively-charged particles 306 and negatively-charged particles 304. The positively-charged particles 306 of the print agent may be attracted to the electrode 106, and the negatively-charged particles 304 are attracted to the print agent transfer roller 110.

The print agent application assembly 100 may, in some examples, further comprise a print agent regulator roller (e.g. a squeegee roller) 114 to regulate a film thickness of print agent on the print agent transfer roller 110. Print agent may pass from the cavity 300 towards the print agent regulator roller 110. The aperture 116 may be such that the portion of print agent that exits the cavity 300 via the aperture 116 may be directed away from the print agent regulator roller.

Thus, as the print agent 302 flows through the cavity 300 towards the squeegee roller 114, some of the print agent is caused to divert from the cavity into the opening or aperture 116 formed through the electrode 106. Since many, if not all, of the negatively-charged particles 304 in the print agent are attracted to the print agent transfer roller 110, the portion of print agent 302 that flows through the aperture 116, and away from cavity 300, contains relatively few, if any, negatively-charged particles.

As noted above, the print agent may comprise a colourant and a thermoplastic resin dispersed in a carrier liquid. The colourant and/or the thermoplastic resin may comprise the charged particles within the print agent and, therefore, some of these portions of the print agent may be attracted to the print agent transfer roller 110. The print agent that flows through the aperture 116 away from the cavity 300 comprises carrier liquid and some positively-charged particles 306 of print agent.

As a result of positively-charged particles 306 being directed away from the cavity 300, the concentration of the negatively-charged print agent particles 304 in the cavity is increased. An effect of the increased concentration of negatively-charged particles 304 is that the electric field E, effects a greater attraction on the negatively-charged particles, thereby causing a more compact, and denser, layer of print agent to be formed on the print agent transfer roller 110.

A further effect of a portion of the print agent 302 flowing away from the cavity 300 via the aperture through the cavity 116 is that the fluid velocity (i.e. the flow rate) of print agent passing through the cavity 300 is reduced. This has an effect that the amount of splashing caused when print agent encounters the squeegee roller 114 is reduced. A combined effect of the denser print agent layer on the print agent transfer roller 110 and the reduced flow velocity of print agent 302 through the cavity 300 is that a more uniform layer of print agent may be formed on the print agent transfer roller and, therefore, fewer print defects, such as flow streaks, may occur during the printing process.

The cavity 300 may, in some example, have a first end and a second end. The first end may, for example, be defined by the region where print agent enters the cavity 300 after flowing between the first and second electrodes 106, 108. The second end of the cavity 300 may, for example, be defined by the squeegee roller 114, or may be considered to be at or near to the squeegee roller 114, where some print agent is compacted onto the print agent transfer roller 110 and some print agent is caused to flow into the ink tray 104. Other surfaces of the print agent application assembly (e.g. BID) 100, such as the part of the housing 102, may define other walls of the cavity. The print agent 302 may therefore flow from the first end of the cavity 300 to the second end of the cavity. The aperture 116 in the electrode 106 may, in some examples, be positioned between the first end and the second end. As noted above, and as shown in FIGS. 1 and 2, the aperture, or opening 116 in the electrode 106 provides a channel or slit through the electrode. The channel, or slit, extends from a first surface of the electrode 106 to a second surface of the electrode, and in the example shown in FIGS. 1 and 2, the channel extends from a surface of the electrode adjacent to the print agent transfer roller 110 to a side surface of the electrode. Specifically, in the example shown in FIG. 1, the channel extends to the side of the electrode 106 adjacent the squeegee roller 114. In this way, print agent 302 that travels through the aperture 116 and through the channel is able to flow into the ink tray 104, where it can be re-used.

In some examples, the aperture 116 in the electrode 106 may be positioned nearer to the second end of the cavity 300 than the first end of the cavity. In this way, there is a sufficient portion of the cavity 300 through which print agent can flow before it encounters the aperture 116 and, therefore, there is a sufficient opportunity for the electric field, E, to act upon the print agent, so as to cause the negatively-charged particles 304 to be attracted to the print agent transfer roller 110 and to cause the positively-charged particles 306 to be attracted to the electrode 106. Thus, by the time the print agent reaches the part of the cavity 302 where the aperture 116 is located, a substantial proportion of the negatively-charged particles 304 may have formed a layer on the print agent transfer roller 110. Thus, the print agent that flows through the aperture 116 is likely to contain a larger proportion of positively-charged particles 306 and relatively few negatively-charged particles 304.

The print agent application assembly 100, 200 may, in some examples, further comprise a print agent capture tray, such as the ink tray 104. As noted above, print agent of the portion of print agent that exits the cavity 300 via the aperture 116 may be received by the print agent capture tray 104. Print agent received by the print agent capture tray 104 may be mixed with other new and/or recycled print agent for re-use. For example, additional colourant may be added to the print agent received in the print agent capture tray 104 to ensure that the print agent is of the intended colour/concentration, and the print agent may then be directed to a print agent reservoir for use in a future printing operation.

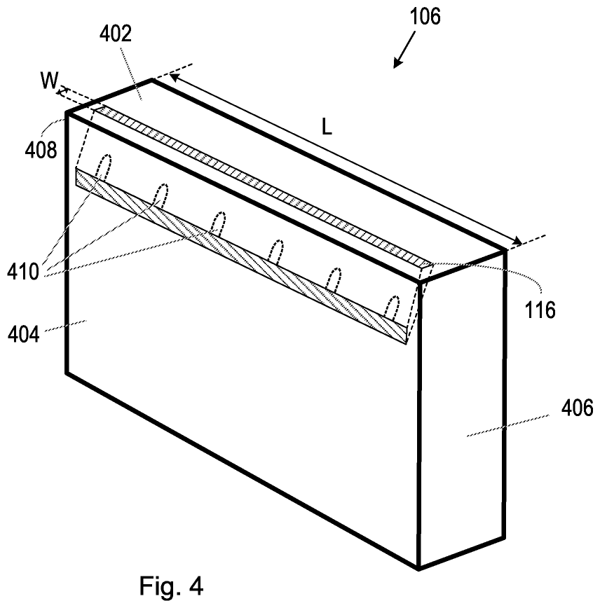

FIG. 4 is an illustration of an example of the electrode 106. The electrode 106 will have a shape and profile according to the shape of the print agent application assembly 100 and according to the shape and arrangement of other components contained within the assembly. The shape of the electrode 106 shown in FIG. 4 is a simplified for illustrative purposes. In FIG. 4, the aperture 116 is shown to extend from a first, upper surface 402 of the electrode 106 to a second, side surface 404 of the electrode. In this example, the aperture 116 takes the form of a slit through the electrode 106. The slit does not extend to end surfaces 406, 408 of the electrode 106 and, therefore, the end surfaces of the electrode prevent the flow of print agent out of the ends of the electrode. The electrode 106 has a length, L, which may be substantially the same as the length of the print agent application assembly. The length, L, may correspond to (e.g. may be substantially equal to) the maximum width of a substance that can be printed on using the print agent application assembly.

Various ways of forming or creating the slit/aperture 116 in the electrode 106 may be implemented. In some examples, such as the example shown in FIG. 4, a plurality of support members (e.g. ribs) 410 may be positioned within the aperture 116 of the electrode 106, to maintain a width of the aperture through the electrode. In other words, the support members or ribs 410 may help to maintain an approximately uniform slit width over the length of the electrode 106. Thus, in some examples, the print agent transfer roller 100 has a length, and the aperture 116 in the electrode 106 may extend substantially over the length of the print agent transfer roller.

The aperture 116 has a width, W, which may be selected based on the intended amount of print agent to flow through the slit away from the cavity 300. In some examples, the aperture 116 in the electrode 106 may have a width of between around 0.5 millimetres and 5 millimetres. In other examples, the aperture 116 may have a width of between around 0.5 millimetres and 2 millimetres.

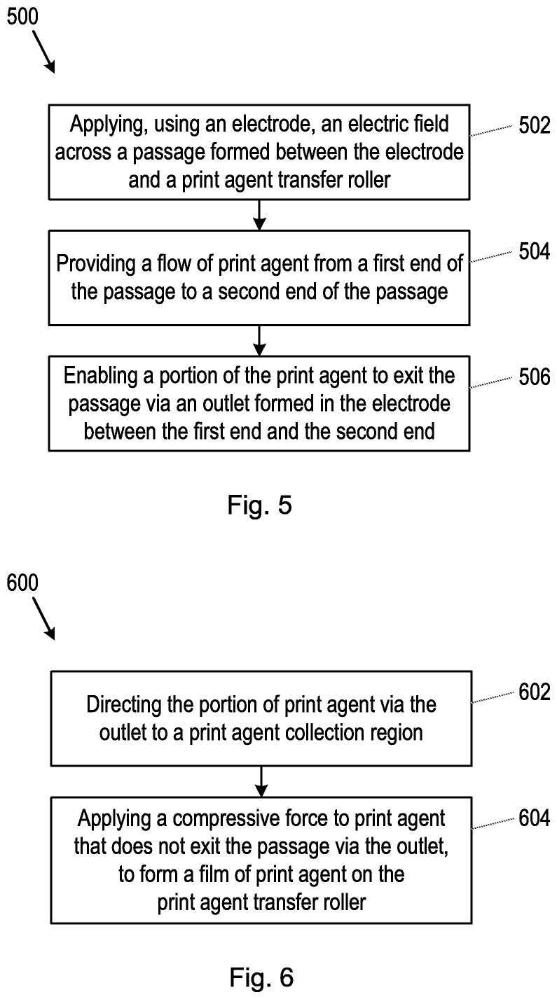

The present disclosure also relates to a method of applying print agent to a print agent transfer roller. FIG. 5 is a flowchart of an example of such a method 500. The method 500 comprises, at block 502, applying, using an electrode 106, an electric field across a passage (e.g. the cavity 300) formed between the electrode and a print agent transfer roller 110. At block 504, the method 500 comprises providing a flow of print agent from a first end of the passage to a second end of the passage. The method 500 comprises, at block 506, enabling a portion of the print agent to exit the passage via an outlet 116 formed in the electrode 106 between the first end and the second end. The method 500 may, in some examples, be performed using the print agent application assembly 100, 200 discussed above.

FIG. 6 is a flowchart of an example of a further method 600 of applying print agent to a print agent transfer roller. The method 600 may include blocks of the method 500 discussed above. In some examples, the method 600 may further comprise, at block 602, directing the portion of print agent via the outlet 116 to a print agent collection region. The print agent collection region may, for example, comprise the ink tray 104.

At block 604, the method 600 may further comprise applying a compressive force to print agent that does not exit the passage via the outlet 116, to form a film of print agent on the print agent transfer roller 110. The compressive force may, in some examples, be applied using the print agent regulator roller, or squeegee roller, 114.

As discussed above, applying a compressive force to the print agent on the print agent transfer roller 110 may help to form a uniform layer of print agent on the transfer roller such that fewer print defects result during the printing process.

In some examples, such as those examples discussed above, the electrode 106 may comprise a negatively-charged electrode, and the print agent in the passage 300 may comprise positively-charged particles and negatively-charged particles. The portion of print agent able to exit the passage 300 via the outlet 116 may comprise more positively-charged particles than negatively-charged particles.

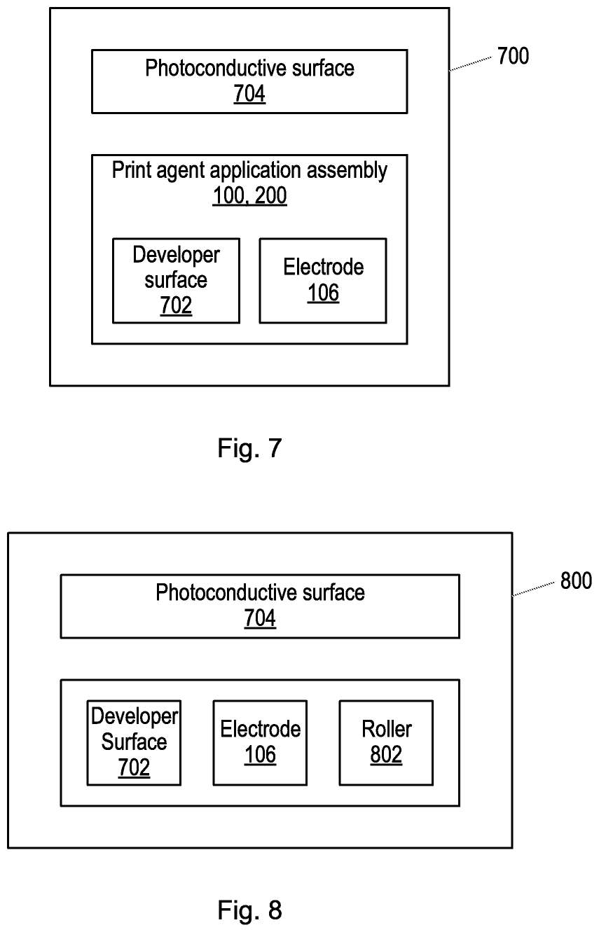

The present disclosure also relates to a print apparatus. FIG. 7 is a schematic illustration of an example of such a print apparatus 700. The print apparatus 700 may be used to perform blocks of the methods 500, 600 discussed above. The print apparatus 700 comprises a print agent application assembly 100, 200 having a developer surface 702 and an electrode 106. The developer surface 702 may, for example, comprise the surface of a developer roller or the print agent transfer roller 110. The print apparatus 700 also comprises a photoconductive surface 704 which may, for example, comprise the surface of a photo imaging plate (PIP). A space between the developer surface 702 and the electrode 106 forms a passage for receiving a flow of print agent to be transferred to the developer surface. The passage may, for example, comprise the cavity 300 discussed above. The print agent application assembly 100, 200 is to transfer a layer of print agent from the developer surface 702 to the photoconductive surface 704. The electrode 106 comprises an aperture 116 to allow a portion of the print agent in the passage to exit the passage to avoid transfer to the developer surface 702. In other words, the aperture 116 allows a portion of print agent in the passage to flow out of the passage without being transferred to the developer surface 702.

FIG. 8 is a schematic illustration of a further example of a print apparatus 800. The print apparatus 800 may include components of the print apparatus 700 discussed above. In the print apparatus 800, the print agent application assembly 100, 200 may further comprise a roller 802 to impart a force to print agent that has been transferred to the developer surface 702. The roller 802 may, for example, comprise the squeegee roller 114 discussed above.

Thus, according to the present disclosure, a slit or opening is formed in an electrode of a print agent application assembly (e.g. a BID) to enable some print agent (particularly liquid carrier and other portions of print agent that are not to be transferred to a substrate during the printing process) to flow away from the cavity wall passage between the electrode and the developer roller, thereby increasing the effect of the electric field on the negatively-charged particles of the print agent, reducing the fluid velocity (i.e. the flow rate) of the print agent through the cavity, causing a denser ink layer to be formed on the developer roller, and reducing the amount of splashing caused when print agent encounters the squeegee roller. An overall effect is that print quality can be improved, and fewer print defects may be caused.

While, according to examples described above, the electrode comprises a single aperture extending substantially across the length of the electrode, in other examples, multiple slits or apertures may be formed, through which print agent can pass in order to flow away from the region between the electrode and the developer roller.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A print agent application assembly comprising:
a print agent transfer roller to receive print agent and transfer a portion of the print agent to a photoconductive surface; and
an electrode to provide an electric charge to the print agent transfer roller;
wherein the print agent transfer roller and the electrode define walls of a cavity through which print agent is to pass; and
wherein the electrode comprises an aperture via which a portion of the print agent is able to exit the cavity.

2. A print agent application assembly according to claim 1, wherein the print agent is to flow from a first end of the cavity to a second end of the cavity; and
wherein the aperture in the electrode is positioned between the first end and the second end.

3. A print agent application assembly according to claim 2, wherein the aperture in the electrode is positioned nearer to the second end than the first end.

4. A print agent application assembly according to claim 1, further comprising:
a print agent capture tray;
wherein print agent of the portion of print agent that exits the cavity via the aperture is to be received by the print agent capture tray.

5. A print agent application assembly according to claim 1, wherein the print agent transfer roller has a length; and
wherein the aperture in the electrode extends substantially over the length of the print agent transfer roller.

6. A print agent application assembly according to claim 1, wherein the aperture in the electrode has a width of between around 0.5 millimetres and 5 millimetres.

7. A print agent application assembly according to claim 1, wherein the electrode comprises a negatively-charged electrode, and the print agent in the cavity comprises positively-charged particles and negatively-charged particles; and
wherein the positively-charged particles of the print agent are attracted to the electrode, and the negatively-charged particles are attracted to the print agent transfer roller.

8. A print agent application assembly according to claim 1, further comprising:
print agent regulator roller to regulate a film thickness of print agent on the print agent transfer roller;
wherein print agent is to pass from the cavity towards the print agent regulator roller;
wherein the aperture is such that the portion of print agent that exits the cavity via the aperture is directed away from the print agent regulator roller.

9. A print agent application assembly according to claim 1, wherein a plurality of support members are positioned within the aperture of the electrode, to maintain a width of the aperture through the electrode.

10. A method comprising:
applying, using an electrode, an electric field across a passage formed between the electrode and a print agent transfer roller;
providing a flow of print agent from a first end of the passage to a second end of the passage; and
enabling a portion of the print agent to exit the passage via an outlet formed in the electrode between the first end and the second end.

11. A method according to claim 10, further comprising:
directing the portion of print agent via the outlet to a print agent collection region.

12. A method according to claim 10, further comprising:
applying a compressive force to print agent that does not exit the passage via the outlet, to form a film of print agent on the print agent transfer roller.

13. A method according to claim 10, wherein the electrode comprises a negatively-charged electrode, and the print agent in the passage comprises positively-charged particles and negatively-charged particles; and
wherein the portion of print agent able to exit the passage via the outlet comprises more positively-charged particles than negatively-charged particles.

14. A print apparatus comprising:
a print agent application assembly having a developer surface and an electrode; and
a photoconductive surface;
wherein a space between the developer surface and the electrode forms a passage for receiving a flow of print agent to be transferred to the developer surface;
wherein the print agent application assembly is to transfer a layer of print agent from the developer surface to the photoconductive surface; and
wherein the electrode comprises an aperture to allow a portion of the print agent in the passage to exit the passage to avoid transfer to the developer surface.

15. A print apparatus according to claim 14, wherein the print agent application assembly further comprises:
a roller to impart a force to print agent that has been transferred to the developer surface.
